(19) United States
(12) Patent Application Publication
(10) Pub. No.: US 2018/0338079 A1
(43) Pub. Date: Nov. 22, 2018

(54) MICROSCOPE SYSTEM, CONTROL METHOD, AND COMPUTER READABLE MEDIUM

(71) Applicant: OLYMPUS CORPORATION, Tokyo (JP)

(72) Inventor: Shingo SUZUKI, Tokyo (JP)

(73) Assignee: OLYMPUS CORPORATION, Tokyo (JP)

(21) Appl. No.: 15/967,951

(22) Filed: May 1, 2018

(30) Foreign Application Priority Data
May 22, 2017 (JP) 2017-100821

(51) Int. Cl. H04N 5/232; G06T 5/00; G06T 5/50

(52) U.S. Cl. CPC H04N 5/23212; G06T 2207/10056; G06T 5/50; G06T 5/006

(57) ABSTRACT

A microscope system includes a correction apparatus to correct a spherical aberration and comprises: a microscope apparatus that obtains a microscopic image; and a control apparatus that causes a display apparatus to display an image evaluation value of the microscopic image and setting information of the correction apparatus at the time of obtaining the microscopic image. The control apparatus causes the display apparatus to display a first image evaluation value of a new microscopic image and first setting information of the correction apparatus at the time of obtaining the new microscopic image, in addition to a second image evaluation value and second setting information that have already been displayed on the display apparatus

### CROSS REFERENCE TO RELATED APPLICATIONS

This application is based upon and claims the benefit of priority from prior Japanese Patent Application No. 2017-100821, filed May 22, 2017, the entire contents of which are incorporated herein by this reference.

### BACKGROUND OF THE INVENTION

### Field of the Invention

The disclosure herein relates to a microscope system, a control method, and a computer readable medium.

### Description of the Related Art

An objective provided with a correction collar for correcting a spherical aberration resulting from the thickness of cover glass is known in the microscopic field (see, for example, Japanese Laid-open Patent Publication No. 05-119263). A correction collar for an objective has conventionally been used exclusively for the purpose of correcting a spherical aberration resulting from the thickness of cover glass. In recent years, a correction collar has also been used for the purpose of correcting a spherical aberration that is changed according to the depth of a target plane of an observed object.

### SUMMARY OF THE INVENTION

A microscope system in accordance with an aspect of the present invention includes: a microscope apparatus that includes a correction apparatus to correct a spherical aberration and that obtains a microscopic image; and a control apparatus that causes a display apparatus to display an image evaluation value of the microscopic image and setting information of the correction apparatus at the time of obtaining the microscopic image. When the microscope apparatus has obtained a new microscopic image, the control apparatus causes the display apparatus to display a first image evaluation value of the new microscopic image and first setting information of the correction apparatus at the time of obtaining the new microscopic image, in addition to a second image evaluation value and second setting information that have already been displayed on the display apparatus.

A control method in accordance with an aspect of the invention is a method of controlling a microscope system that includes: a microscope apparatus that obtains a microscopic image; and a control apparatus that controls a display apparatus. The control method includes: obtaining, by the microscope apparatus, a new microscopic image, the microscope apparatus including a correction apparatus to correct a spherical aberration; and causing, by the control apparatus, the display apparatus to display a first image evaluation value of the new microscopic image and first setting information of the correction apparatus at the time of obtaining the new microscopic image, in addition to a second image evaluation value of a microscopic image that has already been displayed on the display apparatus and second setting information of the correction apparatus at the time of obtaining the microscopic image that has already been displayed on the display apparatus.

A computer readable medium in accordance with an aspect of the invention is a non-transitory computer readable medium having stored therein a program for causing a control apparatus for a microscope system that includes a microscope apparatus that obtains a microscopic image to execute a process. The process includes: causing a display apparatus to display a first image evaluation value of a new microscopic image and first setting information of a correction apparatus at the time of obtaining the new microscopic image, in addition to a second image evaluation value of a microscopic image that has already been displayed on the display apparatus and second setting information of the correction apparatus at the time of obtaining the microscopic image that has already been displayed on the display apparatus, the microscopic image being an image obtained by the microscopic apparatus, the microscopic apparatus including the correction apparatus to correct a spherical aberration.

### BRIEF DESCRIPTION OF THE DRAWINGS

The present invention will be more apparent from the following detailed description when the accompanying drawings are referenced.

FIG. 1 illustrates an exemplary configuration of a microscope system 100.

FIG. 2 illustrates an exemplary configuration of a microscope 20.

FIG. 3 illustrates an exemplary configuration of a control apparatus 40.

FIG. 4 illustrates an exemplary screen displayed on a display apparatus 50.

FIG. 5 is a flowchart of an automatic adjustment process.

FIG. 6 is a diagram for illustrating a method of estimating a recommended position.

FIG. 7 is a flowchart of a manual adjustment process.

FIGS. 8A-8C illustrate exemplary changes in a displayed image within a first display region.

FIGS. 9A-9C illustrate other exemplary changes in a displayed image within a first display region.

FIGS. 10A-10C illustrate yet other exemplary changes in a displayed image within a first display region.

FIGS. 11A-11C illustrate exemplary changes in a displayed image within a second display region.

### DESCRIPTION OF THE EMBODIMENTS

In correcting a spherical aberration using a correction collar, a user of a microscope typically adjusts the setting of the correction collar while observing a change in the brightness or contrast of a microscopic image. However, it is not easy for the microscope user who has viewed the microscopic image to correctly perceive a change in the brightness or contrast of the image.

When a sample comprises components that repeatedly become bright and dark, e.g., GCaMP, or when a portion deep within a sample, for which noise components tend to easily appear on an image, is observed, a change in the brightness or contrast of a microscopic image does not necessarily result from a change in the setting of the correction collar. Hence, even if the microscope user can perceive a change in the brightness or contrast of the image, it will not be easy to correctly evaluate the setting of the correction collar.

In the above-described example, a correction collar is presented as a correction apparatus that corrects a spherical aberration. However, any correction apparatus for correcting a spherical aberration could have similar problems.

Next, descriptions will be given of embodiments of the invention.

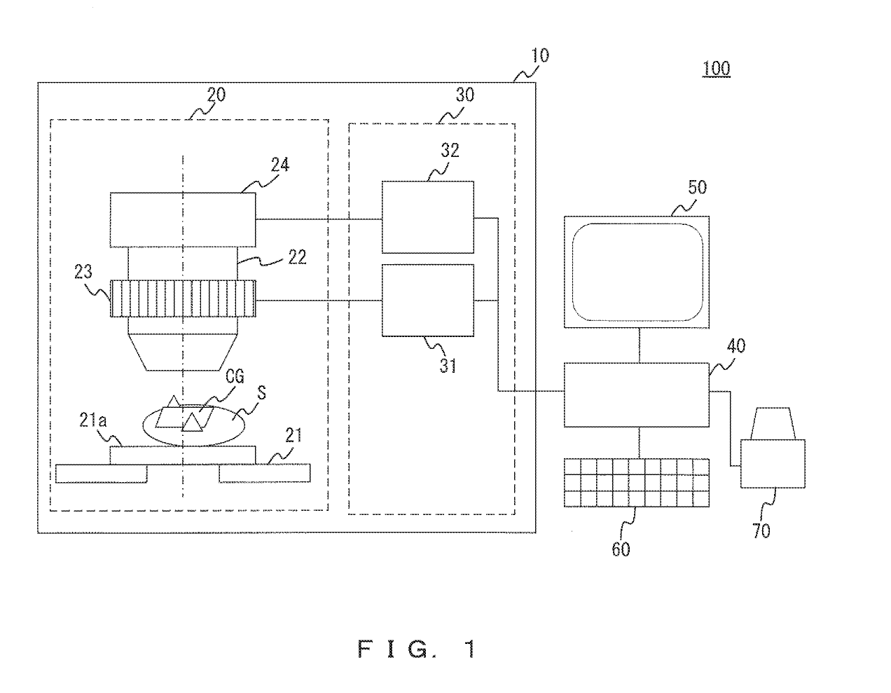

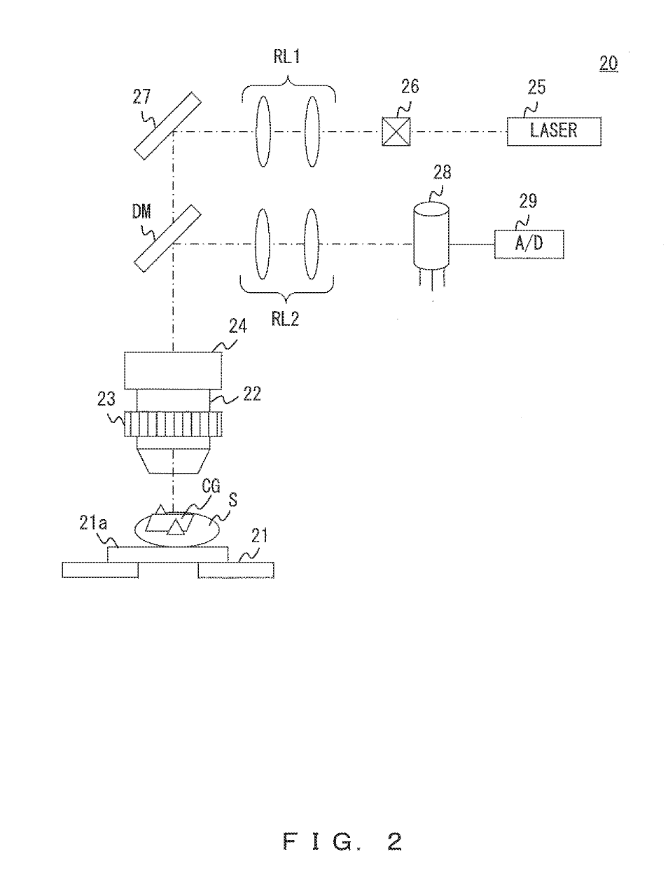

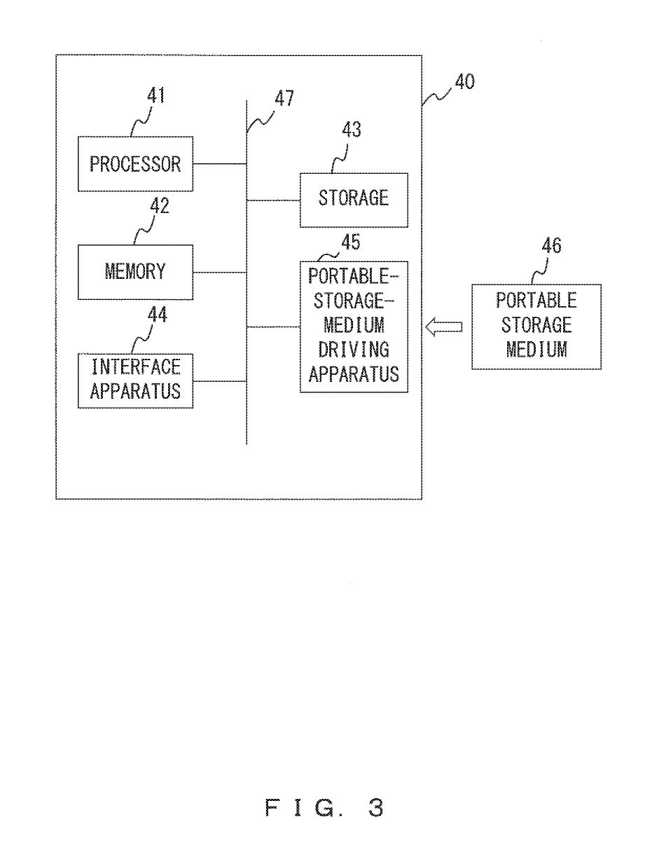

By referring to FIGS. 1-3, the following describes the configuration of a microscope system 100. FIG. 1 illustrates an exemplary configuration of the microscope system 100 in accordance with an embodiment. FIG. 2 illustrates an exemplary configuration of a microscope 20 included in the microscope system 100. FIG. 3 illustrates an exemplary configuration of a control apparatus 40 included in the microscope system 100.

The microscope system 100 depicted in FIG. 1 includes: a microscope apparatus 10 that obtains a microscopic image; a control apparatus 40; a display apparatus 50; and a plurality of input apparatuses (keyboard 60, revolver manipulation apparatus 70) to input an instruction to the control apparatus 40.

The microscope apparatus 10 is, for example, a two-photon excitation microscope apparatus. The microscope apparatus 10 may be a confocal microscope apparatus, a light sheet microscope apparatus, or a light field microscope apparatus. The microscope apparatus 10 includes a microscope 20 and a driving apparatus 30 that drives of components of the microscope 20. The microscope 20 is separated from the driving apparatus 30 in FIG. 1, but the microscope 20 and the driving apparatus 30 may be integral with each other.

The microscope 20 is, for example, a two-photon excitation microscope such as that depicted in FIG. 2. The microscope 20 includes a laser 25, a scanner 26, a relay lens RL1, a mirror 27, a dichroic mirror DM, and an objective 22 provided with a correction collar 23, and a stage 21, all of which are located on an illumination-light path for illumination of a sample S. The objective 22 is mounted on a revolver 24.

The sample S, an object to be observed, is placed on the stage 21. More particularly, a specimen support 21a is placed on the stage 21. The sample S is placed on the specimen support 21a with the top surface of the sample S covered with cover glass CG. The sample S is, for example, a biological sample such as a mouse brain and comprises a calcium probe such as GCaMP.

The laser 25 is, for example, an ultrashort pulse laser and oscillates near infrared laser light. Outputs of the laser 25 are adjusted by the driving apparatus 30 in response to an instruction from the control apparatus 40.

The scanner 26 two-dimensionally scans the sample S with laser light and includes, for example, a galvanometer scanner and a resonant scanner. In the microscope system 100, a zoom magnification is changed by chancing the scan field of the scanner 26. The scan field of the scanner 26 is adjusted by the driving apparatus 30 in response to an instruction from the control apparatus 40.

The relay lens RL1 is a pupil projection optical system that projects the scanner 26 onto a pupil position of the objective 22. The dichroic mirror DM, which is a splitter to separate excitation light (laser light) from detection light (fluorescence) from the sample S, separates laser light from fluorescence in accordance with wavelengths.

The objective 22 is a dry or immersion objective provided with the correction collar 23 and is mounted on the revolver 24. The correction collar 23, which is an exemplary correction apparatus to correct a spherical aberration, moves a lens within the objective 22 to a position that depends on a setting. The correction collar 23 for the objective 22 is an electric correction collar, and the setting of the correction collar 23 is changed by a correction collar driving apparatus 31 in response to an instruction from the control apparatus 40.

The setting of the correction collar 23 refers to the position of the correction collar 23 and, more particularly, the rotation angle of the correction collar 23 relative to a reference position. Hence, changing the setting of the correction collar 23 means changing the position of the correction collar 23, and setting information of the correction collar 23 is information on the position of the correction collar 23.

The revolver 24 is an apparatus that is mounts a plurality of objectives (not illustrated) and that switches an objective to be disposed on a light path. FIGS. 1 and 2 illustrate that an objective 22 provided with the correction collar 23 is disposed on a light path. The revolver 24 is also a focusing apparatus that changes the distance between the stage 21 and the objective 22. The revolver 24 being moved in an optical axis direction of the objective 22 changes the distance between the stage 21 and the objective 22.

FIGS. 1 and 2 depict an example in which the revolver 24 is moved in an optical axis direction of the objective 22; however, the stage 21, instead of the revolver 24, may be moved in the optical axis direction of the objective 22. The stage 21, instead of the revolver 24, may serve as the focusing apparatus for the microscope system 100.

The microscope 20 further includes a relay lens RL2 and photomultiplier tube (hereinafter referred to as PMT) 28 on a detection-light path (path of reflected light from the dichroic mirror DM). A signal output from the PMT 28 is input to an A/D converter 29.

The relay lens RL2 is a pupil projection optical system that projects a pupil of the objective 22 onto the PMT 28. The PMT 28 is an exemplary photodetector and, in this example, outputs an analog signal that depends on the quantity of incident fluorescence. The A/D converter 29 converts an analog signal from the PMT 28 into a digital signal (luminance signal).

The driving apparatus 30 includes the correction collar driving apparatus 31 and a revolver driving apparatus 32. The correction collar driving apparatus 31 drives the correction collar 23 in accordance with an instruction from the control apparatus 40 and changes the setting of the correction collar 23. The revolver driving apparatus 32 drives the revolver 24 in accordance with an instruction from the control apparatus 40 and moves the revolver 24 in an optical axis direction of the objective 22.

The control apparatus 40 is, for example, a standard computer. As depicted in FIG. 3, the control apparatus 40 includes a processor 41, a memory 42, a storage 43, an interface apparatus 44, and a portable-storage-medium driving apparatus 45 into which a portable storage medium 46 is inserted, all of which are mutually coupled via a bus 47.

The processor 41 is, for example, a central processing unit (CPU), a micro processing unit (MPU), or a digital signal processor (DSP) and performs programmed processing by executing a program. The memory 42 is, for example, a random access memory (RAM) and temporarily stores a program or data stored in the storage 43 or the portable storage medium 46 when the program is executed.

The storage 43 is, for example, a hard disk or a flash memory and is used primarily to store various types of data and programs. The interface apparatus 44 is a circuit to exchange signals with apparatuses other than the control apparatus 40 (e.g., microscope apparatus 10, display apparatus 50, keyboard 60, revolver manipulation apparatus 70). The portable-storage-medium driving apparatus 45 accommodates the portable storage medium 46 such as an optical disc or CompactFlash® and writes/reads data to/from the portable storage medium 46. The portable storage medium 46 serves to assist the storage 43. The storage 43 and the portable storage medium 46 are each an exemplary non-transitory computer-readable storage medium that has a program stored therein.

FIG. 2 depicts an exemplary hardware configuration of the control apparatus 40; the control apparatus 40 is not limited to this configuration. The control apparatus 40 may be a dedicated apparatus, not a general purpose apparatus. In place of, or in addition to, a processor for execution of a program, the control apparatus 40 may include electrical circuits such as an application specific integrated circuit (ASIC) and a field programmable gate array (FPGA). These electrical circuits may perform processes described hereinafter.

The display apparatus 50 is, for example, a liquid crystal display, an organic electroluminescence display, or a CRT display. The display apparatus 50 may be provided with a touch panel sensor and, in this case, also functions as an input apparatus.

The revolver manipulation apparatus 70 is an input apparatus for a user of the microscope to designate the position of a target plane of an observed object. The microscope user uses the revolver manipulation apparatus 70 to input to the control apparatus 40 an instruction to change the position of a target plane of an observed object, and under the control of the control apparatus 40, the revolver driving apparatus 32 causes the revolver 24 to move in an optical axis direction. Accordingly, the objective 22 moves in the optical axis direction, with the result that the position of a target plane of an observed object is changed. A target plane of an observed object refers to a plane orthogonal to an optical axis of the objective 22 for which the microscope apparatus 10 obtains an image, e.g., a focal plane of the objective 22 in obtaining an image.

In the microscope system 100 configured as described above, the microscope apparatus 10 scans the sample S with laser light using the scanner 26 in a direction orthogonal to an optical axis of the objective 22 and detects fluorescence from various positions on the sample S using the PMT 28. In addition, a digital signal (luminance signal) obtained by converting a signal from the PMT 28 is two-dimensionally mapped to generate image data of a microscopic image, and the generated image data is output to the control apparatus 40.

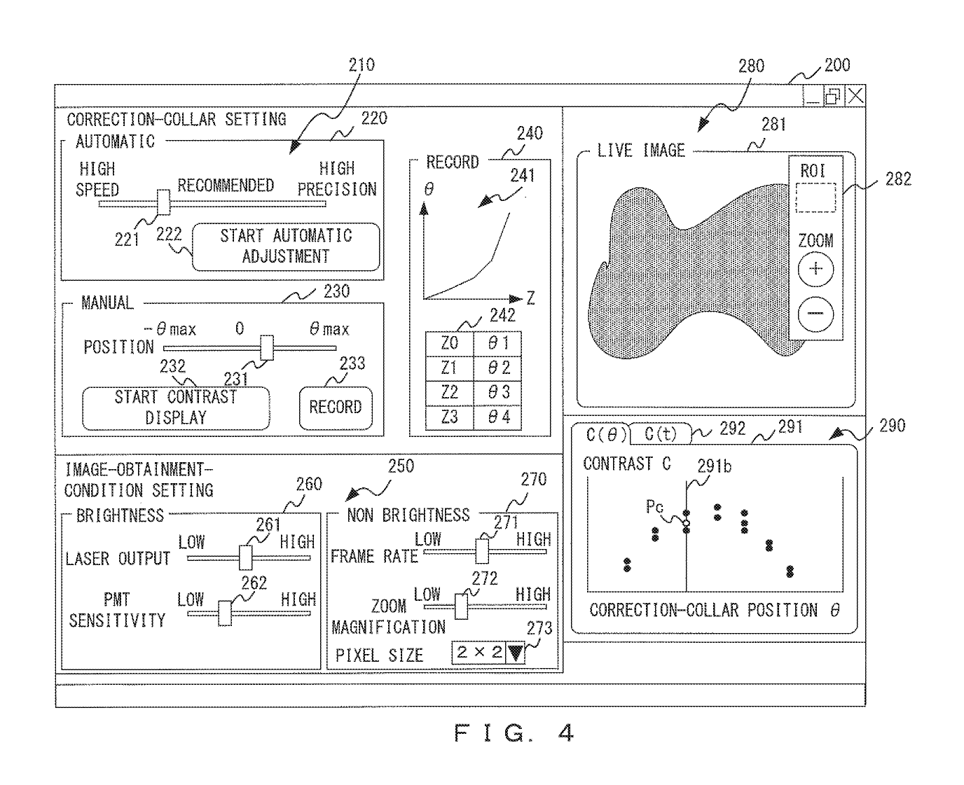

The following describes a method of adjusting the setting of the correction collar 23. FIG. 4 illustrates an exemplary screen displayed on the display apparatus 50. A screen 200 is a setting screen to change various settings of the microscope system 100 and includes a correction-collar setting region 210, an image-obtainment-condition setting region 250, an image display region 280, and a contrast display region 290.

The correction-collar setting region 210 relates to the setting of the correction collar 23 and includes an automatic setting region 220, a manual setting region 230, and a record display region 240. The automatic setting region 220 is operated for automatic adjustment of the setting of the correction collar 23. The manual setting region 230 is operated for manual adjustment of the setting of the correction collar 23. The record display region 240 is a region within which is displayed a relationship determined between the position of a target plane of an observed object and a recommended setting of the correction collar 23 on the basis of the setting information of the correction collar 23 that has been obtained through automatic or manual adjustment, i.e., the recommended setting of the correction collar 23 that depends on an observation depth.

The image-obtainment-condition setting region 250, which is a region for setting conditions under which a microscopic image is obtained, includes a brightness setting region 260 and a non-brightness-condition setting region 270. The brightness setting region 260 is a region operated in adjusting the brightness of a microscopic image. The non-brightness-condition setting region 270 is a region operated in adjusting image obtainment conditions that is not a brightness condition and, in particular, a frame rate, a zoom magnification, a pixel size (binning), and the like.

The image display region 280, which is a region within which a microscopic image is displayed, includes a live-image display region 281 and a toolbar 282. A microscopic image obtained by the microscope apparatus 10 is continuously displayed within the live-image display region 281 while the image is updated repeatedly at certain time intervals. The toolbar 282 has arranged therewithin a tool for designating a region of interest (ROI) on a microscopic image displayed within the live-image display region 281, and a zoom button for changing a display magnification for the microscopic image.

The contrast display region 290, which is a region within which an image contrast, i.e., an exemplary image evaluation value, is displayed, includes a first display region 291 and a second display region 292 that are displayed through switching using a tab. The first display region 291 is a region within which are displayed the contrast of a microscopic image obtained by the microscope apparatus 10 and the position at which the correction collar 23 was located in obtaining the image. The second display region 292 is a region within which a change in a contrast over time is displayed.

An image evaluation value correlates with a spherical aberration calculated from image data of a microscopic image. A contrast, i.e., an exemplary image evaluation value, is calculated on the basis of a difference between pixel values included in an image. In a known method, in order to calculate a contrast, the square of the difference between the pixel values of two pixels located at positions distant from each other by n pixels in an x direction is summed over the entirety of image data. An image evaluation value is not limited to the contrast of a microscopic image and may be the brightness of the microscopic image (e.g., average luminance). Both a contrast and a brightness are highly correlated with a spherical aberration and become greater as the spherical aberration is corrected to a higher degree.

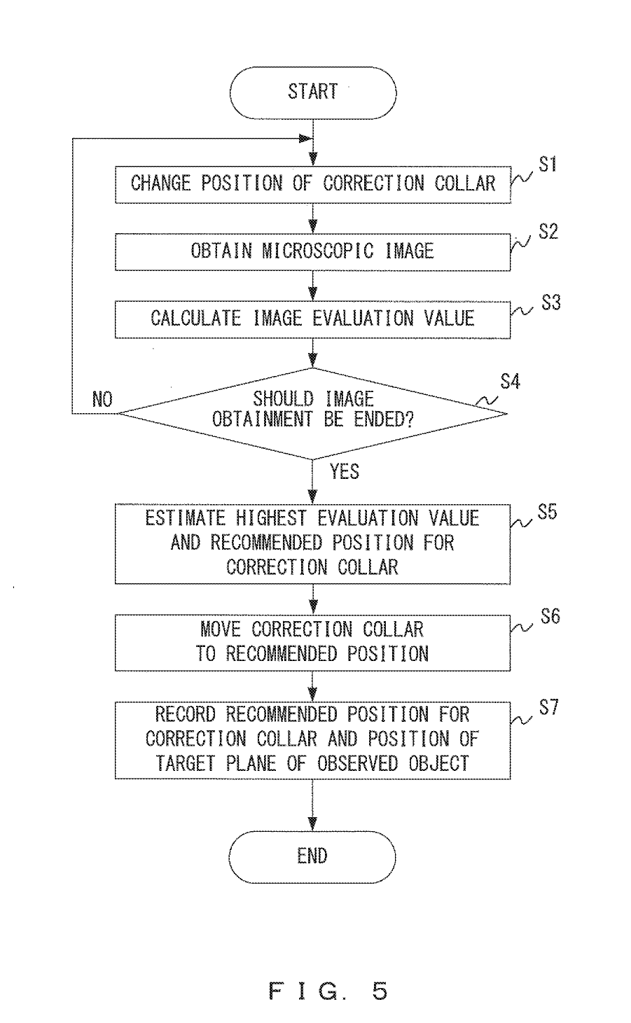

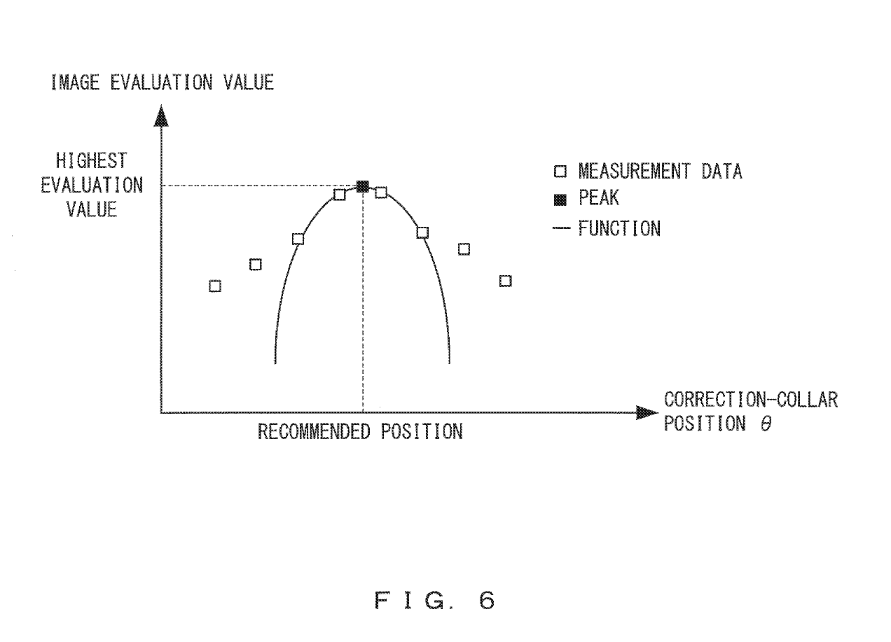

FIG. 5 is a flowchart of an automatic adjustment process. FIG. 6 is a diagram for illustrating a method of estimating a recommended position. A user of the microscope clicking a button 222 in the automatic setting region 220 causes the microscope system 100 to start the automatic adjustment process depicted in FIG. 5.

The control apparatus 40 changes the position of the correction collar 23 (step S1). In this example, the control apparatus 40 selects one position from a predetermined number of (8 in this example) positions. Each of positions equally divides the range of motion of the correction collar 23. These positons hereinafter referred to as candidate positions. And the control apparatus 40 controls the correction collar driving apparatus 31 so as to move the correction collar 23 to the selected candidate position.

The number of candidate positions may be set in accordance with, for example, the position of a slider 221 within the automatic setting region 220. For example, fewer number of candidate positions may be set as the position of the slider 221 becomes closer to “High speed”.

The microscope apparatus 10 obtains a microscopic image (step S2), and the control apparatus 40 calculates an image evaluation value for the microscopic image (step S3). In this example, the control apparatus 40 calculates a contrast as the image evaluation value.

The control apparatus 40 determines whether to end image obtainment (step S4). In this example, the control apparatus 40 determines whether microscopic images have been obtained for all of the candidate positions; when microscopic images have not been obtained for all of the candidate positions, the control apparatus 40 repeats the processes of steps S1-S3.

When microscopic images have been obtained for all of the candidate positions, the control apparatus 40 estimates a highest evaluation value and a recommended position for the correction collar 23 (step S5). In this example, the control apparatus 40 may estimate that the highest of the plurality of image evaluation values calculated in step S3 is the highest evaluation value for the current position of a target plane of an observed object and that the position at which the correction collar 23 was located when the microscopic image with the calculated highest evaluation value was obtained is the recommended position. Alternatively, the control apparatus 40 may select three or more points from a plurality of points. The plurality of points are measurement data in FIG. 6. The plurality of points is identified, as depicted in, for example, FIG. 6, by the plurality of image evaluation values calculated in step S3 and positions of the correction collar 23 that correspond to the plurality of image evaluation values. And the control apparatus 40 may calculate a function of a position of the correction collar 23 and an image evaluation value via interpolation or function approximation of the selected points. A peak position of the calculated function (the peak indicated in FIG. 6) may be estimated to correspond to the highest evaluation value and the recommended position for the current position of a target plane of the observed object.

The interpolation may be any interpolation method such as Lagrange interpolation or spline interpolation. The function approximation may be any approximation method such as the least squares method.

When a recommended position is estimated, the control apparatus 40 moves the correction collar 23 to the recommended position by controlling the correction collar driving apparatus 31 (step S6). The control apparatus 40 records the recommended position for the correction collar 23 estimated in step S5 and the current position of a target plane of the observed object (step S7) and ends the automatic adjustment process. In this example, the control apparatus 40 records in the storage 43 the recommended position and the position of a target plane of the observed object. On the basis of the recorded information, the control apparatus 40 updates a graph 241 and table 242 that indicate a relationship between the recommended position and the position of a target plane of the observed object.

The microscope system 100 performing the automatic adjustment process depicted in FIG. 5 enables the setting of the correction collar 23 to be automated. Hence, the user of the microscope can easily make settings for the correction collar 23 in accordance with the position of a target plane of the observed object.

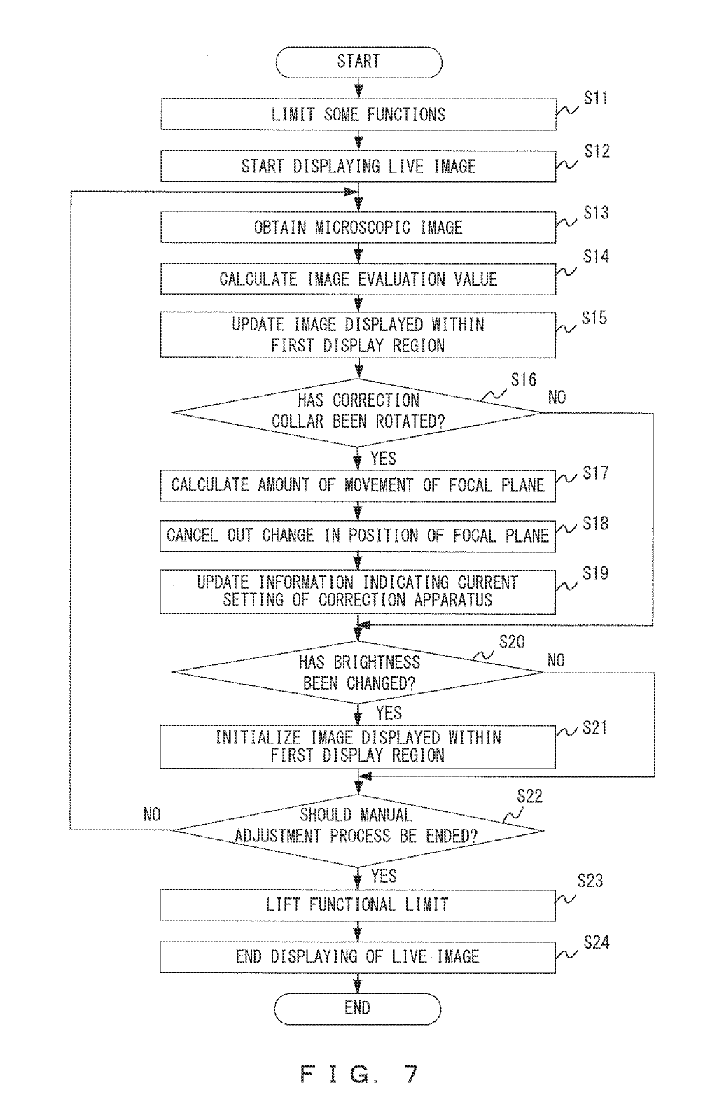

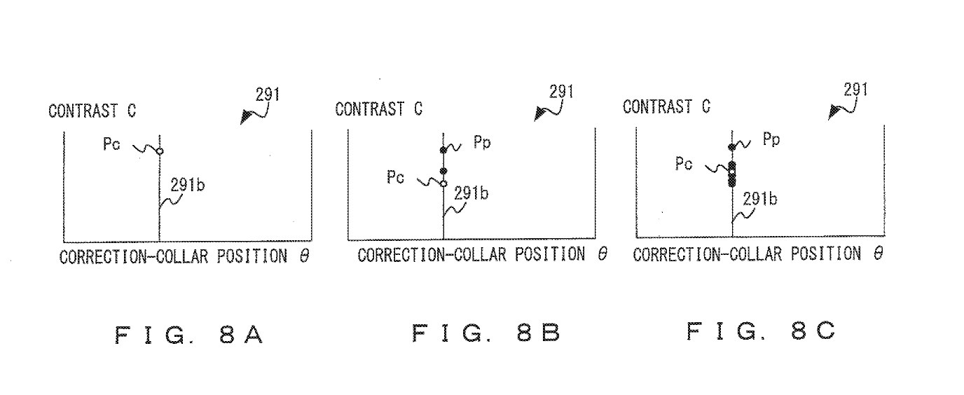

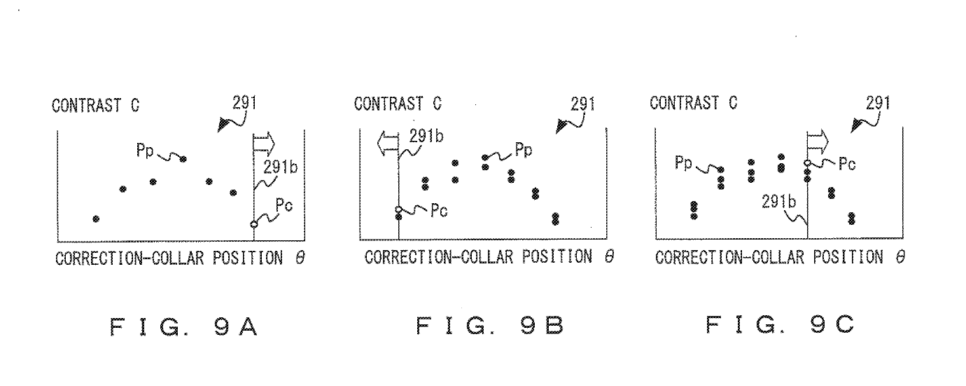

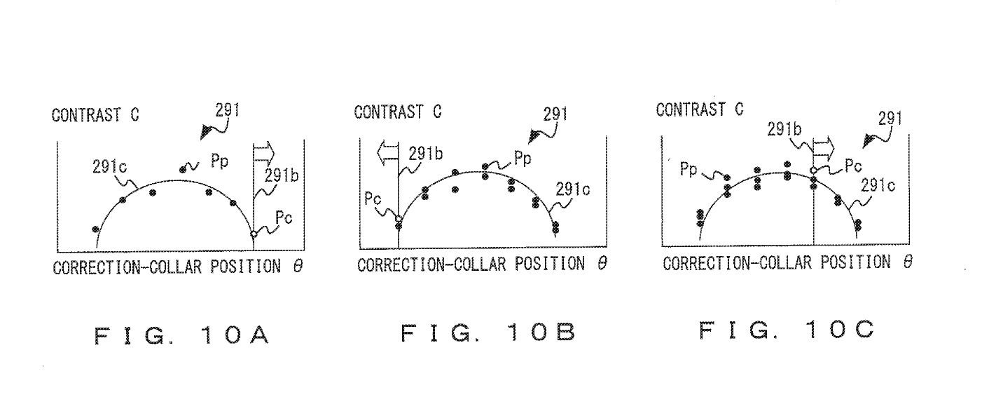

FIG. 7 is a flowchart of a manual adjustment process. FIGS. 8A-8C illustrate exemplary changes in a displayed image within a first display region. FIGS. 9A-9C illustrate other exemplary changes in a displayed image within a first display region. FIGS. 10A-10C illustrate yet other exemplary changes in a displayed image within a first display region. A user of the microscope clicking a button 232 in the manual setting region 230 causes the microscope system 100 to start the manual adjustment process depicted in FIG. 7.

The control apparatus 40 limits some functions of the microscope system 100 (step S11). In this example, the control apparatus 40 invalidates, for example, the non-brightness-condition setting region 270 so as to disable a slider 271, a slider 272, and a list box 273. This prevents the frame rate, the zoom magnification, the pixel size, and the like from being changed. The position of a target plane of the observed object is also prevented from being changed by the revolver driving apparatus 32. In addition, when past information is displayed within the contrast display region 290, the information is erased to initialize the image displayed within the contrast display region 290.

The control apparatus 40 starts displaying a live image (step S12). In this example, the control apparatus 40 controls the display apparatus 50 so as to display a microscopic image obtained by the microscope apparatus 10 within the live-image display region 281.

In addition, the microscope apparatus 10 obtains a microscopic image (step S13), and the control apparatus 40 calculates an image evaluation value for the microscopic image obtained by the microscope apparatus 10 (step S14). In this example, the control apparatus 40 calculates a contrast as the image evaluation value.

When the microscope user has designated an ROI on the live-image display region 281 by operating the keyboard 60, the control apparatus 40 calculates, in step S14, an image evaluation value (contrast) on the basis of a portion of the microscopic image that corresponds to the designated ROI.

Upon the image evaluation value being calculated, the control apparatus 40 updates the image displayed within the first display region 291 (step S15). In this example, the control apparatus 40 causes the display apparatus 50 to display, within the first display region 291, the contrast of the microscopic image calculated in step S14 and setting information (position information) of the correction collar 23 at the time of obtaining the microscopic image.

When the microscope apparatus 10 has obtained a new microscopic image while information is already displayed within the first display region 291, the display apparatus 50 is caused to display the image evaluation value of the new microscopic image and setting information of the correction collar 23 at the time of obtaining the new microscopic image, in addition to the already displayed image evaluation value and setting information. More particularly, information is additionally displayed every time a microscopic image is obtained.

In step S15, the contrasts of microscopic images and setting information of the correction collar 23 are desirably displayed graphically within the first display region 291. For example, as depicted in FIG. 4, the control apparatus 40 may plot a point Pc indicating the contrast of a microscopic image and setting information of the correction collar 23 on a two-dimensional region within the first display region 291. The two-dimensional region is with a vertical axis indicating contrast C and a horizontal axis indicating the position θ of the correction collar. Using such a method, the control apparatus 40 may cause the display apparatus 50 to graphically display the contrast of a microscopic image and setting information of the correction collar 23. In addition, information indicating a current setting of the correction collar 23 may be displayed within the displayed graph. The graph shows the contrasts of microscopic images and setting information of the correction collar 23. For example, an auxiliary line 291b may be displayed at a position that corresponds to the current setting of the correction collar 23, as depicted in FIG. 4.

The control apparatus 40 determines whether the correction collar 23 has been rotated (step S16). In this example, the control apparatus 40 determines whether the correction collar 23 has been rotated on the basis of, for example, whether a slider 231 in the manual setting region 230 has been manipulated.

When the correction collar 23 has been rotated, the control apparatus 40 controls the focusing apparatus in accordance with the amount of rotation of the correction collar 23 (step S17, step S18). In this example, the control apparatus 40 calculates the amount of movement of a focal plane of the objective 22 that results from the rotation of the correction collar 23 (step S17). In particular, a unit correction amount (μm/deg) recorded in advance for each objective is read from the storage 43, and the amount of movement of the focal plane is calculated by multiplying the unit correction amount corresponding to the objective 22 by the amount of rotation of the correction collar 23. A unit correction amount indicates the amount of movement of a focal plane that corresponds to a unit amount of rotation of the correction collar. The control apparatus 40 controls the revolver 24 on the basis of the amount of movement calculated in step S17 so as to cancel out the change in the position of the focal plane (step S18).

The control apparatus 40 updates information indicating the current setting of the correction collar 23 (step S19). In this example, the control apparatus 40 changes the positon of the auxiliary line 291b displayed within the first display region 291, in a manner such that the auxiliary line 291b displayed within the first display region 291 indicates the position of the correction collar 23 after the rotation.

The control apparatus 40 determines whether the brightness has been changed (step S20). In this example, the control apparatus 40 determines whether the brightness has been changed on the basis of, for example, whether at least one of slider 261 or 262 within the brightness setting region 260 has been manipulated. When the brightness has been changed, the control apparatus 40 erases and initializes the information displayed within the first display region 291 (step S21).

The control apparatus 40 determines whether to end the manual adjustment process (step S22). In this example, when, for example, the microscope user inputs an end instruction, the control apparatus 40 determines to end the manual adjustment process.

The control apparatus 40 repeats steps S13-S22 until the microscope user inputs the end instruction. When the end instruction is input, the control apparatus 40 lifts the functional limit set in step S11 (step S23) and ends the displaying of the live image (step S24), thereby ending the manual adjustment process. When a button 233 is clicked during the manual adjustment process, the control apparatus 40 may record the positions at which the correction collar 23 and a target plane of the observed object are located at the time at which the button 233 is clicked. In this case, on the basis of the recorded information, the control apparatus 40 may update the graph 241 and table 242 that indicate a relationship between a recommended position and the position of a target plane of the observed object. The recording process performed in response to the clicking of the button 233 is not necessarily performed during the manual adjustment process but may be performed after the manual adjustment process is performed.

As a result of the microscope system 100 performing the manual adjustment process depicted in FIG. 7, when a new microscopic image is obtained, an image evaluation value and setting information calculated on the basis of the new microscopic image are additionally displayed within the first display region 291.

Hence, by holding the correction collar 23 at a predetermined position during the manual adjustment process, the microscope user can grasp, on the basis of the information displayed within the first display region 291, a variation in contrast that depends on, for example, the blinking of a sample S itself. In particular, every time the microscope apparatus 10 obtains a microscopic image, a contrast is calculated, and a point is added to a position on the auxiliary line 291b. The point indicates the calculated contrast. As a result, the displayed image is changed as depicted in, for example, FIGS. 8A-8C, and many points will be plotted on the auxiliary line 291b after passage of a certain period of time. Hence, the microscope user can easily grasp a variation in contrast from the state of the distribution of points on the auxiliary line 291b.

In the first display region 291, the latest point Pc is indicated by an open circle, and existing points Pp are indicated by filled circles. More particularly, every time a new point is plotted, one existing point is changed from an open circle to a filled circle.

In addition, by changing the position of the correction collar 23 during the manual adjustment process, the microscope user can grasp a position at which the correction collar 23 is to be located to correct a spherical aberration effectively, in addition to a variation in contrast. In particular, for example, the correction collar 23 may be caused to move from one end to another of the range of motion back and forth several times, thereby changing the displayed image as depicted in FIGS. 9A-9C. As a result, a relationship between the setting information (position information) of the correction collar 23 and a contrast, as well as a variation in the contrast, is displayed within the first display region 291. This allows the microscope user to correctly grasp a relationship between setting information of the correction collar 23 and a contrast with a variation in the contrast in mind. Hence, the microscope user can correctly grasp a recommended position for the correction collar 23 that is suitable for the current position of a target plane of an observed object.

As described above, in the microscope system 100, quantitative data (image evaluation value) correlated with a spherical aberration is displayed on the display apparatus 50. A variation in the data (image evaluation value) may be visually grasped from the information displayed on the display apparatus 50. Hence, the setting of the correction collar 23 to correct a spherical aberration can be easily and correctly evaluated.

FIGS. 8A-8C and FIGS. 9A-9C depict examples in which a scatter diagram indicating a relationship between a contrast, i.e., an image evaluation value, and setting information of the correction collar 23 is displayed within the first display region 291. Displaying graphic information such as the scatter diagram allows the microscope user to more easily grasp a variation in contrast. Hence, the microscope user can more easily and correctly evaluate the setting of the correction collar 23.

Meanwhile, FIGS. 8A-8C and FIGS. 9A-9C depict examples in which the auxiliary line 291b indicating a current setting of the correction collar 23 is displayed within the displayed graph. Displaying information indicating the current position of the correction collar 23, such as the auxiliary line 291b, allows the microscope user to easily grasp a target position, i.e., a position the correction collar 23 is to be located, relative to the current position. The microscope user easily grasps the direction toward the target position. This facilitates the task of adjusting the correction collar 23 performed by the microscope user during the manual adjustment process.

In the microscope system 100, a region of interest is designated, and the control apparatus 40 calculates an image evaluation value (contrast) on the basis of a portion of a microscopic image that corresponds to the region of interest. This enables the microscope user to evaluate the setting of the correction collar 23 on the basis of the contrast of the region of interest. Accordingly, even when a range of visual field for which a microscopic image is obtained includes regions with different refractive indexes, a recommended position for the correction collar 23 to observe a region of interest in a preferable manner can be correctly grasped.

As depicted in FIGS. 10A-10C, the control apparatus may cause the display apparatus 50 to display an approximation curve 291c indicating a relationship between a contrast and setting information of the correction collar 23 in addition to the scatter diagram. The approximation curve 291c may be calculated using any approximation method, e.g., the least squares method. Alternatively, the approximation curve 291c may be calculated using any interpolation method such as Lagrange interpolation or spline interpolation. The approximation curve 291c may be calculated every time a new microscopic image is obtained or every time a contrast is calculated; the control apparatus 40 may update the displayed approximation curve 291c together with updating the displayed scatter diagram, as depicted in FIGS. 10A-10C. Displaying the approximation curve 291c allows the microscope user to more easily grasp a recommended position for the correction collar 23 that is suitable for the current position of a target plane of the observed object.

When the setting of the correction collar 23 is changed in the microscope system 100, the control apparatus 40 automatically controls the revolver 24 that serves as a focusing apparatus, so as to reduce a variation in the focal plane. This allows a variation in an image evaluation value that would be caused by positional deviation of a target plane of an observed object to be reduced without the microscope user performing a special task. Hence, the setting of the correction collar 23 that corrects a spherical aberration can be evaluated more easily and correctly.

When the setting of the control apparatus 40 is changed regarding brightness in the microscope system 100, information displayed within the first display region 291 is erased to initialize the image displayed within the first display region 291. This enables the microscope user to be prevented from considering an incorrect position to be a recommended position for the correction collar 23 due to contrasts calculated from microscopic images obtained under different settings for brightness.

In the example described above, the setting of the correction collar 23 is manually adjusted by referring to the information on a contrast that is displayed within the first display region 291; however, the microscope user may adjust the brightness before adjusting the setting of the correction collar 23. This is because a variation in a contrast can be reduced by improving the S/N ratio of a microscopic image through appropriate adjustment of the brightness.

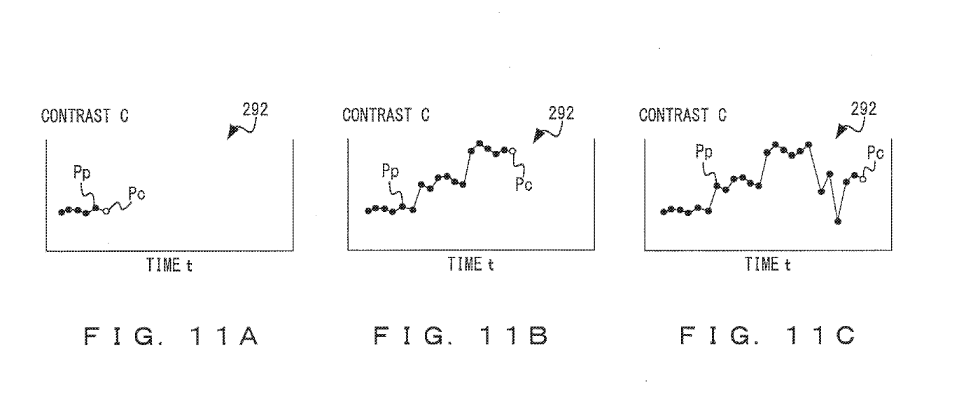

To adjust brightness, first, a tab is operated to display the second display region 292 within the contrast display region 290. As a result, the control apparatus 40 displays a change in a contrast over time graphically within the second display region 292 of the display apparatus 50. Then, the microscope user gradually increases the brightness of the image by manipulating the slider 261 or 262 while maintaining the position of the correction collar 23. This changes the image displayed within the second display region 292, as depicted in, for example, FIGS. 11A-11C.

A contrast typically becomes higher as a microscopic image becomes brighter, but when saturation occurs, an estimated difference in brightness between pixels becomes small, and the contrast becomes low. Accordingly, by checking the image displayed within the second display region 292, the microscope user can recognize that saturation would occur in the brightness setting in the case of displaying the image depicted in FIG. 11C and that the brightness setting in the case of displaying the image depicted in FIG. 11B will provide the highest contrast and a high S/N ratio.

As described above, the control apparatus 40 causes the display apparatus 50 to display a change in a contrast over time, so that the microscope user can easily find a brightness setting suitable for the setting of the correction collar 23. Hence, the setting of the correction collar 23 can be more easily and correctly evaluated.

The described embodiments indicate specific examples to facilitate understanding of the invention, and embodiments of the present invention are not limited to them. Various modifications and changes can be made to the microscope system, the control method, and the computer readable medium without departing from the scope of the recitations of the claims.

The correction collar 23 is indicated as a correction apparatus in the described embodiments, but the correction apparatus is not limited to the correction collar 23. Any component can be the correction apparatus, as long as it can change the amount of a spherical aberration caused on a light path. For example, the correction apparatus may be an apparatus that moves a lens that constitutes an optical system of the microscope apparatus 10, or may be an apparatus that uses Liquid crystal on silicon (LOCOS)®, a deformable mirror (DFM), or a liquid lens. The correction apparatus is not limited to an apparatus controlled by the control apparatus 40. For example, in place of the correction collar 23 that is an electric correction collar, a manually operated correction collar and a sensor that detects the position of the correction collar may function as the correction apparatus. In this case, the control apparatus 40 controls the image displayed within the contrast display region 290 on the basis of position information of the correction collar output from the sensor.

In the embodiments described above, a region of interest is designated, and the control apparatus 40 calculates an image evaluation value (contrast) on the basis of a portion of a microscopic image that corresponds to the designated region of interest. However, a region on a sample S for which the microscope apparatus 10 captures an image may be limited to a region of interest. That is, the microscope user may designate a region for which an image is to be captured.

In the embodiments described above, during the manual adjustment process depicted in FIG. 7, the control apparatus 40 controls the focusing apparatus so as to reduce a variation in a focal plane that is caused by rotation of the correction collar 23. However, the control apparatus 40 may perform a similar control operation during the automatic adjustment process depicted in FIG. 5, in addition to during the manual adjustment process depicted in FIG. 7.

In the embodiments described above, the image displayed within the contrast display region 290 is updated during the manual adjustment process depicted in FIG. 7. However, the image displayed within the contrast display region 290 may be updated during the automatic adjustment process, in addition to during the manual adjustment process. The update of the image displayed within the contrast display region 290 during the automatic adjustment process enables a variation in a contrast that occurs in the automatic adjustment process to be visually checked. Hence, the certainty and reliability of a result of the automatic adjustment can be estimated.

In the embodiments described above, an image evaluation value is calculated every time the microscope apparatus 10 obtains a microscopic image. However, the timing of calculating an image evaluation value is not particularly limited. For example, an image evaluation value may be calculated every time a predetermined number of microscopic images are obtained.

What is claimed is:

1. A microscope system comprising:
a microscope apparatus that includes a correction apparatus to correct a spherical aberration and that obtains a microscopic image; and
a control apparatus that causes a display apparatus to display an image evaluation value of the microscopic image and setting information of the correction apparatus at a time of obtaining the microscopic image, wherein
when the microscope apparatus has obtained a new microscopic image, the control apparatus causes the display apparatus to display a first image evaluation value of the new microscopic image and first setting information of the correction apparatus at a time of obtaining the new microscopic image, in addition to a second image evaluation value and second setting information that have already been displayed on the display apparatus.

2. The microscope system of claim 1, wherein
the correction apparatus includes a correction collar for an objective,
the microscope apparatus includes
a stage on which an observed object is placed, and
a focusing apparatus that changes a distance between the stage and the objective, and
when the correction collar has been rotated, the control apparatus controls the focusing apparatus in accordance with an amount of rotation of the correction collar.

3. The microscope system of claim 2, wherein
when the correction collar has been rotated, the control apparatus
calculates an amount of movement of a focal plane of the objective that results from the rotation of the correction collar, and
controls the focusing apparatus on the basis of the calculated amount of movement so as to cancel out a change in a position of the focal plane of the objective that results from the rotation of the correction collar.

4. The microscope system of claim 1, wherein
the control apparatus causes the display apparatus to graphically display the image evaluation value and the setting information.

5. The microscope system of claim 2, wherein
the control apparatus causes the display apparatus to graphically display the image evaluation value and the setting information.

6. The microscope system of claim 3, wherein
the control apparatus causes the display apparatus to graphically display the image evaluation value and the setting information.

7. The microscope system of claim 4, wherein
the control apparatus causes the display apparatus to display information indicating a current setting of the correction apparatus within a graph showing the image evaluation value and the setting information.

8. The microscope system of claim 5, wherein
the control apparatus causes the display apparatus to display information indicating a current setting of the correction apparatus within a graph showing the image evaluation value and the setting information.

9. The microscope system of claim 6, wherein
the control apparatus causes the display apparatus to display information indicating a current setting of the correction apparatus within a graph showing the image evaluation value and the setting information.

10. The microscope system of claim 4, wherein
the control apparatus causes the display apparatus to display a scatter diagram indicating a relationship between the image evaluation value and the setting information, and an approximation curve calculated from the image evaluation value and the setting information.

11. The microscope system of claim 5, wherein
the control apparatus causes the display apparatus to display a scatter diagram indicating a relationship between the image evaluation value and the setting information, and an approximation curve calculated from the image evaluation value and the setting information.

12. The microscope system of claim 6, wherein
the control apparatus causes the display apparatus to display a scatter diagram indicating a relationship between the image evaluation value and the setting information, and an approximation curve calculated from the image evaluation value and the setting information.

13. The microscope system of claim 1, wherein
the control apparatus causes the display apparatus to graphically display a change in the image evaluation value over time.

14. The microscope system of claim 2, wherein
the control apparatus causes the display apparatus to graphically display a change in the image evaluation value over time.

15. The microscope system of claim 3, wherein
the control apparatus causes the display apparatus to graphically display a change in the image evaluation value over time.

16. The microscope system of claim 1, wherein
the control apparatus calculates a brightness or contrast of the microscopic image as the image evaluation value.

17. The microscope system of claim 16, further comprising:
an input apparatus to designate a region of interest, wherein
the control apparatus calculates the image evaluation value on the basis of a portion of the microscopic image that corresponds to the region of interest.

18. A method of controlling a microscope system including a microscope apparatus that obtains a microscopic image and a control apparatus that controls a display apparatus, the method comprising:
obtaining, by the microscope apparatus, a new microscopic image, the microscope apparatus including a correction apparatus to correct a spherical aberration; and
causing, by the control apparatus, the display apparatus to display a first image evaluation value of the new microscopic image and first setting information of the correction apparatus at a time of obtaining the new microscopic image, in addition to a second image evaluation value of a microscopic image that has already been displayed on the display apparatus and second setting information of the correction apparatus at the time of obtaining the microscopic image that has already been displayed on the display apparatus.

19. A non-transitory computer readable medium having stored therein a program for causing a control apparatus for a microscope system that includes a microscope apparatus that obtains a microscopic image to execute a process comprising:
causing a display apparatus to display a first image evaluation value of a new microscopic image and first setting information of a correction apparatus at a time of obtaining the new microscopic image, in addition to a second image evaluation value of a microscopic image that has already been displayed on the display apparatus and second setting information of the correction apparatus at a time of obtaining the microscopic image that has already been displayed on the display apparatus, the microscopic image being an image obtained by the microscopic apparatus, the microscopic apparatus including the correction apparatus to correct a spherical aberration.
